(19) United States
(12) Patent Application Publication
(10) Pub. No.: US 2011/0298309 A1
(43) Pub. Date: Dec. 8, 2011

(54) ACTUATOR MODULE APPLICABLE TO VARIOUS FORMS OF JOINT

(75) Inventors: Byoung Soo Kim, Seoul (KR); Wook Jang, Gwangmyeong (KR)

(73) Assignee: ROBOTIS CO., LTD., Seoul (KR)

(21) Appl. No.: 13/009,463

(22) Filed: Jan. 19, 2011

(30) Foreign Application Priority Data
Jun. 4, 2010 (KR) 10-2010-0052965
Jun. 4, 2010 (KR) 10-2010-0052967

(51) Int. Cl. H02K 7/00

(52) U.S. Cl. 310/17

(57) ABSTRACT

The present invention is about actuator modules that can be applied to various forms of joints and about joint structure using such modules, and the actuator modules includes actuator body comprising of electronics system and drive system and a separately connected decelerator, and the speed and torque obtained from the first deceleration of the actuator module body can be easily changed through the second decelerator, and since the decelerator separately connects with the actuator body it can be applied to various forms of decelerator and the actuator body can be placed varyingly making it applicable to various joint forms, and said actuator modules can be used form various joint structure.

### BACKGROUND OF THE INVENTION

The present invention relates to a polyarticular robot and in particular to an actuator module that can be applied to various forms of joints of a polyarticular robot.

A polyarticular robot is a type of robot with multiple joint sections sharing the rotation axle, and the joint sections comprise actuators that provide the driving power and various forms of coupling elements that connect the actuators. A driving power of the polyarticular robot is only provided by actuator modules and coupling elements connected directly to the driving axle of actuator modules.

But, it is difficult to make the control program of each actuator module and it becomes difficult to change the speed and torque generated from a single actuator module, because mechanical parts of each actuator module individually control the speed and torque of each joint section. Since all joints must include more than one actuator modules, it is not easy to form various forms of joint structure, while consuming numerous number of actuator modules.

Also, in case of a polyarticular robot, for example, more torque is needed when rotating the joint section in the opposite direction of the external force such as gravitational force being applied compared to when rotating the joint section in the direction of the external force being applied. However, there is no way to compensate the insufficient torque, and the only way to obtain more torque is to use larger actuator modules which may become an obstacle when miniaturizing a polyarticular robot structure.

### SUMMARY OF THE INVENTION

It is an object of the present invention to provide an actuator module that can easily change the speed and torque obtained from the first deceleration from the actuator module body comprising a decelerator for second deceleration that is separately connected with the actuator body.

It is a further object of the present invention to provide an actuator module with various forms of decelerators, and be applied to various forms of joints.

It is a further object of the present invention to provide an actuator module that can compensate the insufficient torque and maintain the balance of weight, increase the durability of the wiring, make wiring arrangement easier, make wiring without disassembling the actuator modules when assembling or disassembling polyarticular robots.

It is a further object of the present invention to provide an actuator module applicable to various joint forms and to design a polyarticular robot easier.

The above objects have been achieved by an actuator module that comprises an actuator body including circuit parts and mechanical parts; and a decelerator that is connected to the actuator body to change the speed and the torque generated by the actuator body.

In accordance with additional aspect of the present invention, the decelerator is separated from the actuator body; and the actuator body and the decelerator is connected by a frame.

In accordance with additional aspect of the present invention, the decelerator is directly and coaxially coupled with the actuator body.

In accordance with additional aspect of the present invention, a load balancer is installed at the actuator body or the decelerator's rotation axle for the compensation of a driving torque.

In accordance with additional aspect of the present invention, a slip ring is installed at the actuator body or the decelerator's rotation axle.

In accordance with additional aspect of the present invention, the decelerator is selected from the group consisting of a belt and pulley structure, a harmonic drive, and a gear structure.

In accordance with additional aspect of the present invention, an encoder is formed at the actuator body or the decelerator, for sensing the operating status including rotation angle of the driving axle and feeding the sensed information back to the circuit parts of the actuator body.

In accordance with additional aspect of the present invention, an external port is formed on one side of the actuator body for connection with an external sensor.

In accordance with additional aspect of the present invention, the actuator module further comprises an additional decelerator connected to the actuator body or the decelerator's driving axle to change the driving torque generated by the actuator body or the decelerator.

In accordance with another aspect of the present invention, the actuator module comprises an actuator body generating driving power; a decelerator connected to the actuator body to change the speed and the torque generated by the actuator body; a frame interconnecting the actuator body and the decelerator; a load balancer installed on the driving axle of the actuator body or the decelerator to compensate for the driving torque of the actuator body or the decelerator; and a slip ring that is installed on the driving axle to supply electric power through the driving axle.

According to the present invention, an actuator module comprises actuator body and a decelerator which is separately connected to the actuator body. The actuator module can easily change the speed and torque obtained from the first deceleration of the actuator module body into the second deceleration of the separate decelerator.

Also, according to the present invention, the actuator module can apply to various forms of decelerators. The decelerator and actuator body may be arranged in various ways since the decelerator is separated from the actuator body.

Also, according to the present invention, the actuator module can compensate the insufficient torque and maintain the balance of weight due to the load balancer mounted on the actuator body or the driving axle or the rotating axle of the decelerator. Further, due to a slip ring, the actuator module may increase the durability of the wiring, make wiring arrangement easier, and make wiring without disassembling the actuator modules when assembling or disassembling polyarticular robots.

Also, according to the present invention, the actuator module comprises primarily of 4 large sections of actuator body section, decelerator section, various forms of frame section that can be connected to the actuator body or driving axle of the decelerator, and accessory section such as slip ring and load balancer. Therefore the actuator module can expand into several of joint forms and make design of polyarticular robot easy.

### BRIEF DESCRIPTION OF THE DRAWINGS

FIG. 1 illustrates a conceptual diagram of the actuator module according to the present invention.

FIG. 2 illustrates an actuator module according to a first embodiment of the present invention.

FIG. 3 illustrates an actuator module according to a second embodiment of the present invention.

FIG. 4 illustrates an actuator module according to a third embodiment of the present invention.

FIGS. 5, 6, and 7 show a polyarticular robot's joints formed by the actuator module according to the first embodiment of the present invention.

FIGS. 8 and 9 show a polyarticular robot's joints formed by the actuator modules according to the first and third embodiment of the present invention, respectively.

FIG. 10 shows a slip ring installed on the actuator module of the present invention.

FIGS. 11, 12, 13, and 14 illustrate a load balancer installed on the actuator module of the present invention.

### DETAILED DESCRIPTION OF PREFERRED EMBODIMENTS

With reference to drawings, below are detailed descriptions of several embodiments of the present invention.

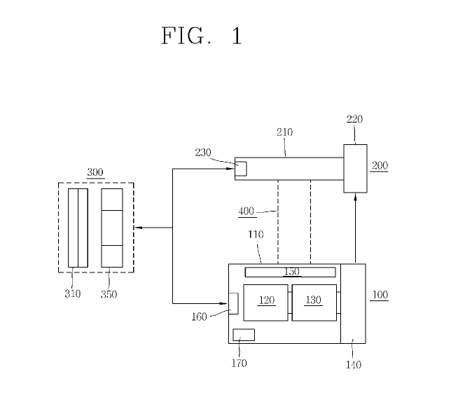

FIG. 1 illustrates a conceptual diagram of the actuator module according to the present invention.

The actuator module according to the present invention comprises an actuator body 100 and a decelerator 200. The actuator body 100 comprises a mechanical part that includes a motor 120, a gear section 130 and a driving pulley 140, and a circuit part that includes an electronic circuitry 150 and various sensors connected to the electronic circuitry 150. Selectively, an encoder 160 to deliver an operating status signal of the mechanical part to the electronic circuitry 150 of the circuit part may be built in the actuator body 100. An external port 170 for electric connection with external devices such as external sensors can be built in the actuator body 100.

The decelerator 200 is available in variety of form such as a belt and pulley structure, a harmonic drive, and a gear structure, etc. In FIG. 1, a belt and pulley structure including the connecting axle 210 and a driven pulley 220 are shown as an example. The actuator module according to the present invention comprises a frame 400 to connect the actuator body 100 and the decelerator 200 physically or mechanically. The decelerator 200 preferably comprises a decelerator encoder 230 to deliver the operating status signal such as rotation angle of decelerator's driving axle to the electronic circuitry 150 of the actuator body 100. The frame 400 is fabricated as part of the actuator body 100 or as a separate piece and connected with the actuator body 100 in various ways using various known connection methods.

In FIG. 1, the actuator module according to the present invention comprises accessories 300 such as a load balancer 310 or a slip ring 350 that can be selectively installed on a driving axle of the actuator body 100 or the decelerator 200.

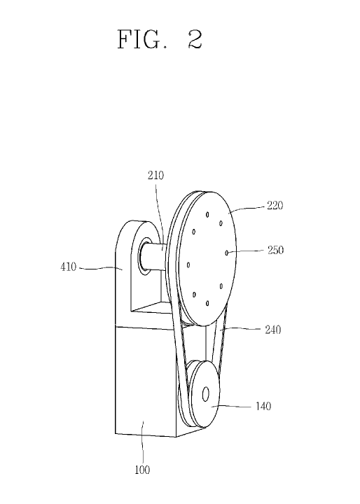

FIG. 2 illustrates an actuator module according to a first embodiment of the present invention.

The actuator module according to the first embodiment of the present invention comprises the actuator body 100 having a driving pulley 140, a decelerator having a belt 240, a driven pulley 220 and a connecting axle 210, and a Π-shape frame 410 for forming a hinge structure that mechanically connects the actuator body 100 with the decelerator 200.

The actuator body 100 comprises a gear section 130 consisting of multiple gears that firstly decelerate the driving speed of the motor 120 (shown in FIG. 1) and interconnecting the motor 120 with the driving pulley 140. The driving pulley 140 is connected to the driven pulley 220 of the decelerator by the belt 240, and it delivers the driving power firstly decelerated from the gear section 130 of the actuator body 100 to the driven pulley 220 of the decelerator 200. The driven pulley 220 secondly decelerates the driving speed and increases the driving torque to deliver the driving power to the external coupling element (not shown) connected through the insert hole 250 of the driven pulley 220.

The Π-shaped frame 410, for example, comprises a base section connected to the actuator body 100, and a pair of side frames perpendicular to the base section. Each side frame comprises axle insert holes to which the connecting axle 210 can be inserted.

The connecting axle 120 can be connected between the pair of side frames to axle insert holes in a fixed state or in a rotatable state by use of a bearing. One end of the connecting axle 120 is connected to the driven pulley 220 and the other end of the connecting axle 120 is connected to the external coupling element (not shown). This connection allows the actuator module comprising the actuator body 100, the Π-shaped frame 410 and the decelerator 200 to rotatably connect to the external coupling element (not shown).

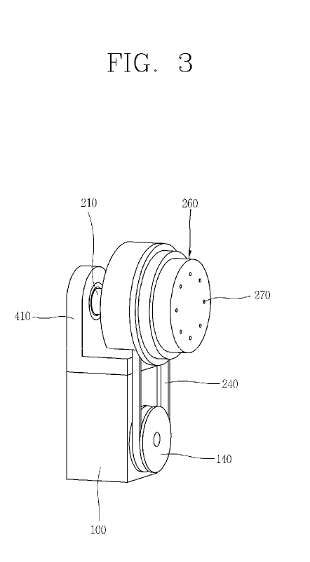

FIG. 3 illustrates an actuator module according to a second embodiment of the present invention.

The actuator module according to the second embodiment of the present invention further comprises a harmonic drive 260 in comparison to the first embodiment of the FIG. 2. The harmonic drive 260 and the driven pulley (not shown in FIG. 3) are coaxially connected to the connecting axle 210. The harmonic drive 260 generates additional torque by decelerating for the third time the driving power that was decelerated for the second time and increased in torque by the driven pulley 220. The harmonic drive 260 comprises the insert holes 270 on the outer surface for connection with external coupling elements.

As seen from above, due to the multiple decelerating means such as the driven pulley 220 and the harmonic drive 260, the adjustment of driving speed and torque becomes easier and eventually small actuator modules can be used to generate sufficient torque when large torques are needed. One of the major characteristics of the present invention is that in addition to the deceleration function within the actuator body 100 itself, at least one additional decelerators can be installed outside of the actuator body 100, which allows the driving speed and driving torque to be easily controlled, and the delivery location of driving power can be configured in various ways.

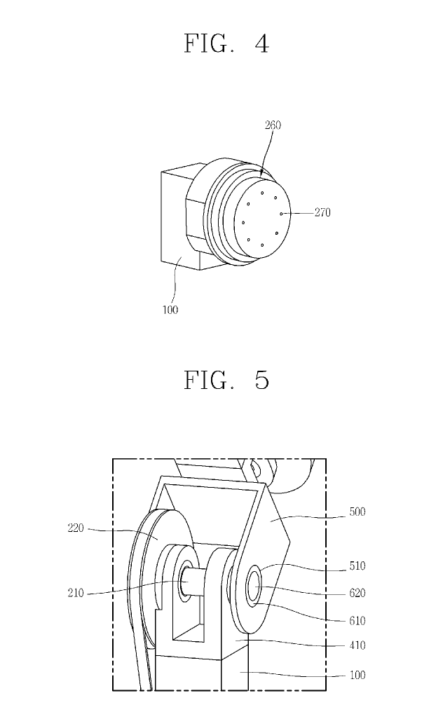

FIG. 4 illustrates an actuator module according to a third embodiment of the present invention.

In FIG. 4, the driving axle of an actuator body 100 operates as a connecting axle with a decelerator which comprises a harmonic drive 260, and thus the driving power of the actuator body 100 is coaxially delivered. In addition to the harmonic drive, planetary gear, spur gear, and various other known gear structures that can be physically connected to the actuator body 100 can be provided as the decelerators. The harmonic drive 260 in FIG. 4 comprises the insert holes 270 that make connection with the external coupling elements easy.

In the above explained embodiments, the second or third decelerators such as the driven pulley or the harmonic drive may comprise an encoder 121 that detects the operating status of the decelerator such as rotation angle and feedback the detected information to the electronic circuitry 150 (i.e. control system) of the actuator body 100 for more accurate control of the driving power.

FIGS. 5, 6, and 7 show polyarticular robot's joints formed by the actuator module according to the first embodiment of the present invention.

First, in FIG. 5, a coupling element 500 is connected to the actuator module of FIG. 2. It shows the joint section a slip ring structure comprised of outer ring 610, inner ring 620 and connecting line (not shown) connected to the coupling element 500 by connect axle insert holes 510.

The coupling element 500 is comprised of Π-shaped frame, and connecting axle insert holes 510 are formed respectively on each of the side frames. The left end of the connecting axle 210 connects to the left side frame through the driven pulley 220 and the right end of the connecting axle 210 connects to the right side frame through the slip ring structure. The rotation of coupling element 500 is ensured not only when the connecting axle 210 is rotatable but also when the connecting axle 210 is a fixed axle. Since the driven pulley 220 and the slip ring structure both have a rotatable structure, even if the connecting axle 210 is a fixed axle, the external coupling elements 500 connected to both ends of the connecting axle has a hinge structure with the connecting axle working as the driving shaft that allow rotation or swings. The slip ring structure generally refers to an electric component that supplies power to a rotating section.

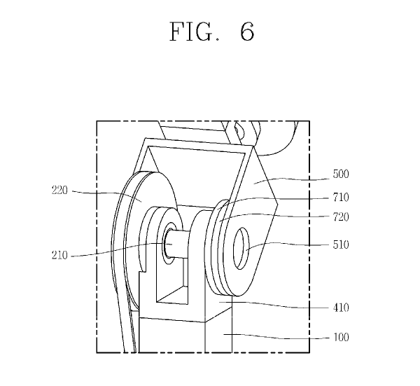

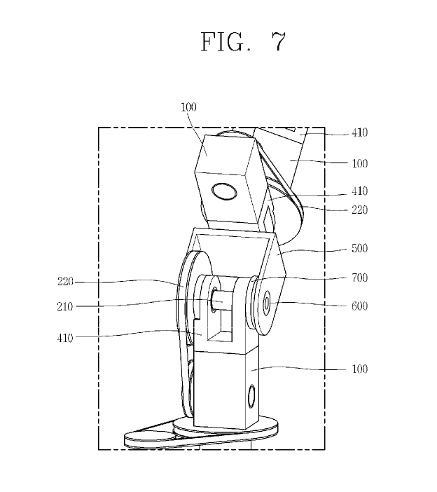

Next, in case of FIG. 6, it shows a joint section where the coupling element 500 is connected to the actuator module of FIG. 2. A load balancer comprised of fixed element 710 and rotational element 720 is mounted on one end of the connecting axle 210 connected to the coupling element 500.

In FIG. 6, in case of a polyarticular robot, the load being applied the rotation axle of the joint section is typically different according to the rotating direction of the joint. For example, in case of the humanoid type polyarticular robot's knee joint, more load is applied to the knee joint when the robot moves to standing position compared to kneeling position. Also, in case of a robot arm, more load is applied to the joint section when a joint axle rotates in the opposite direction of gravity than when the joint axle rotates in the direction of gravity.

In typical polyarticular robots, the rotation movement of joint sections is solely dependent on the driving power of the actuator, and more torque is required from the actuator when the joint is rotated in the opposite direction of gravity. To generate larger torque, an actuator with larger capacity is required and very precise torque control is required which makes it difficult to develop the control program for controlling of the actuator's drive system and to miniaturize the polyarticular robot. In addition, in the joint areas where larger torque is required, the risk of overload in the drive system of actuator and the resulting power consumption, malfunction or breakdown becomes greater.

FIG. 7 shows multiple joint structures of a polyarticular robot comprising actuator modules having the structures of slip ring 600 and load balancer 700 connected to a single joint section and coupling elements 500.

In the joint section shown in FIG. 7, if the ratio of the diameter of a driving pulley (not shown) of the actuator body 100 to the diameter of a driven pulley 220 is for example 1:n, the deceleration rate becomes 1:n or 1/n, and the driving torque of the driven pulley 220 increases inversely proportional to the deceleration rate. Accordingly, the coupling element 500 and the upper actuator modules connected to it use the larger driving torque to slowly rotate.

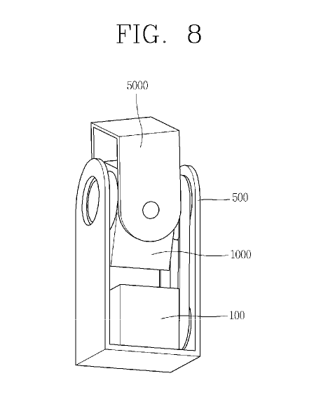

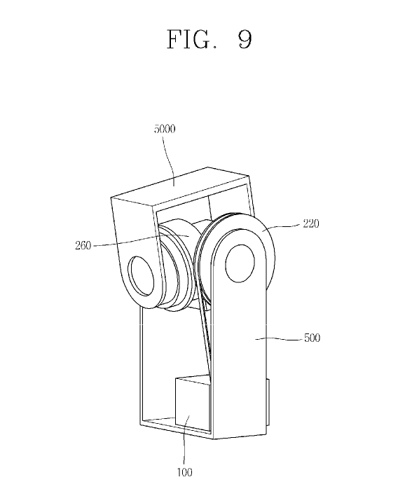

FIGS. 8 and 9 show a polyarticular robot's joint seen from different directions and formed by the combination of the actuator modules according to the first and the third embodiments of the present invention. The joint has two degrees of freedom using two actuator bodies 100.

The frame of the first actuator module having separately connected decelerator (for example, a driven pulley 220) in the first embodiment is provided as a first coupling element 500 surrounding the first actuator body 100. A second actuator module having coaxially coupled decelerator (for example, a harmonic drive 260) in the second embodiment is inserted between the side frames of the first coupling element 500. Both ends of driving axle of the second actuator body 1000 are connected with a second coupling element 5000. The second actuator body 1000 is inserted between the side frames of the first coupling element 500 by a protruding connecting section (not shown) on the outside of the second actuator body 1000 that is perpendicular to the driving axle of the second actuator body 1000.

The second coupling element 5000 is rotated by the driving torque from the harmonic drive 260 of the second actuator body 1000, and first coupling element 500 is rotated by the driving torque from the driven pulley 220 of the first actuator body 100. At this time, if the second actuator body 1000 is in a state fixed to the driven pulley 220, the first actuator body 100 will swing around the axle of the driven pulley 220.

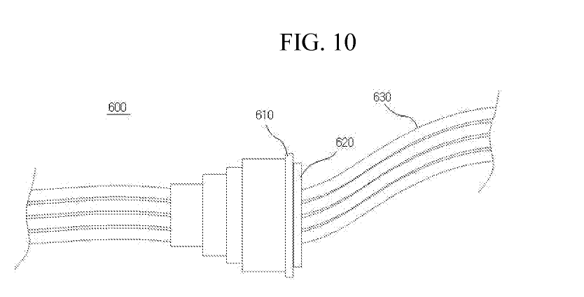

FIG. 10 shows a slip ring structure installed on the actuator module of the present invention.

A slip ring 600 comprises an outer ring 610, an inner ring 620, and a wiring 630 connected to the outer ring 610 and the inner ring 620. The outer ring 610 and the inner ring 620 of the slip ring 600 have the securely rotatable structure, where one of the outer and inner rings is mechanically fixed and the other is rotatable while maintaining electrical connections. This configuration increases the durability of joint structure and wiring arrangement by preventing the wires from being twisted and makes the wiring arrangement simple by eliminating any interference problems between wires and other mechanical parts such as a coupling element 500 or actuator module. An external connector for the wiring 630 connection is installed on the inner ring 620 of the slip ring structure 600 to enable easy wiring arrangement without disassembling the actuator body 100 or the actuator modules.

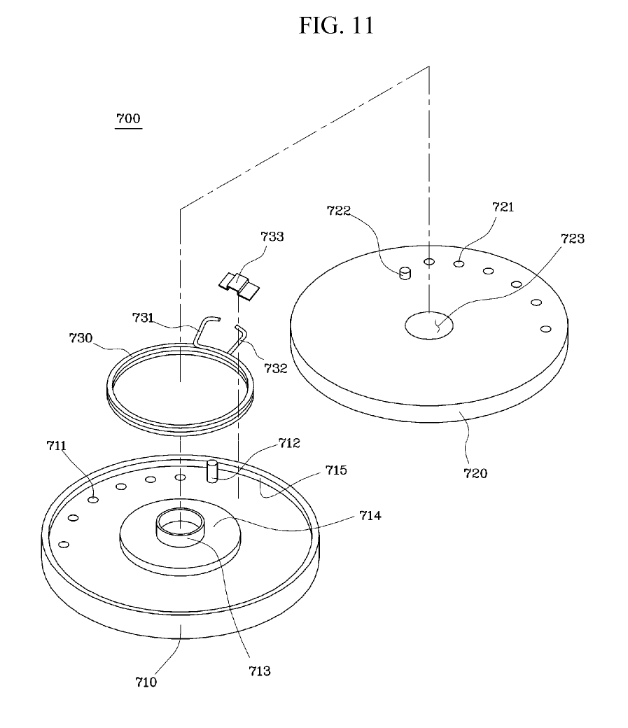

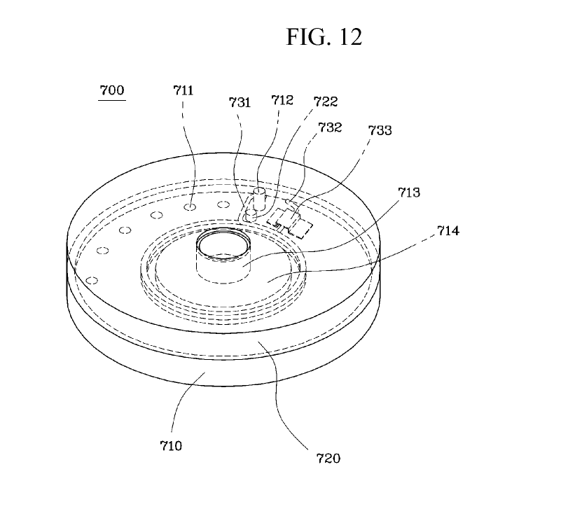

FIGS. 11, 12, 13, and 14 illustrate a load balancer installed on the actuator module of the present invention.

The load balancer 700 is mounted on the rotating axle of a joint structure of a polyarticular robot in order to compensate insufficient torque when relatively large torque is required for driving the joint structure. It also balances the loads applied to the joint structure.

The load balancer 700 comprises of a fixed element 710 installed on one end of a fixed, first joint element such as the actuator module (or frame), a rotational element 720 installed on one end of a rotatable, second joint element such as an external coupling element 500, and an elastic element 730 installed between the fixed element 710 and the rotational element 720 for generating additional torque in opposite direction of the rotating direction of the rotational element 720. The fixed element 710 and the rotational element 720 are installed on the first and second joint elements respectively, and rotate in opposite direction to each other according to the rotation movements of the joint elements. Thus, it must be understood that terms ‘fixed’ and ‘rotational’ are interchangeable and defined only for the convenience of explanation.

The load balancer 700 generates compensation torque in only one direction, and generally the compensation torque is generated in the opposite) direction of gravity or in the direction to which more load is applied. If FIG. 6 is the knee joint section of a humanoid robot, due to the effects of weight of robot itself and the gravity, more torque is required when the robot is unbending its knee joints (i.e. to the opposite direction of gravity) compared to when the robot is bending its knee joints (i.e. to the direction of gravity). The load balancer 700 forms a structure of compensating a substantial amount of the total torque required for unbending the knee joints.

The fixed element 710 and the rotational element 720 may be formed in flat board shaped elements, and an axle insert hole 723 is formed in the center for connection with the connecting axle 210. An elastic element 730 in the form of a torsion spring and a rotational connecting element 714 in the form of bearing are installed between the fixed element 710 and the rotational element 720.

A support section 713 is formed on the inner surface of the fixed element 710 to support the rotational connecting element 714 and interconnect the fixed element 710 and the rotational element 720. A sill 715 is formed on the outer diameter of the fixed element 710, and this provides the space to accommodate the elastic element 730 and the rotational connecting element 714. At this time, according to the design of the skilled in the art, the support section 713 and the sill 715 can be formed on the rotational element 720 or on both the fixed element 710 and the rotational element 720.

On the inner surface of at least one of the fixed element 710 and rotational element 720, multiple insert holes 711, 721 are punched along a virtual concentric circle and a reference protrusion 712 is inserted in one of the insert holes 711, 721.

On the inner surface of the fixed element 710 a fixing member 733 is formed to secure the fixed end section 732 of the elasticity element 730, and the moving end section 731 of the elasticity element 730 is hung on the reference protrusion 712. The initial location of the load balancer 700 or the distance between both ends 731, 732 of the elasticity element 730 and the reference location is determined according to the location of the insert holes 711, 721. The insert location of the reference protrusion 712 can be arbitrarily adjusted by the user, and the amount of torque compensated by the load balancer 700 is determined by the insert location of the reference protrusion 712 and the elasticity of the elasticity element 730.

On the inner surface of the rotational element 720 a fixed protrusion 722 is formed to move the moving end section 731 of the elasticity element according to the rotation of the rotational element 720.

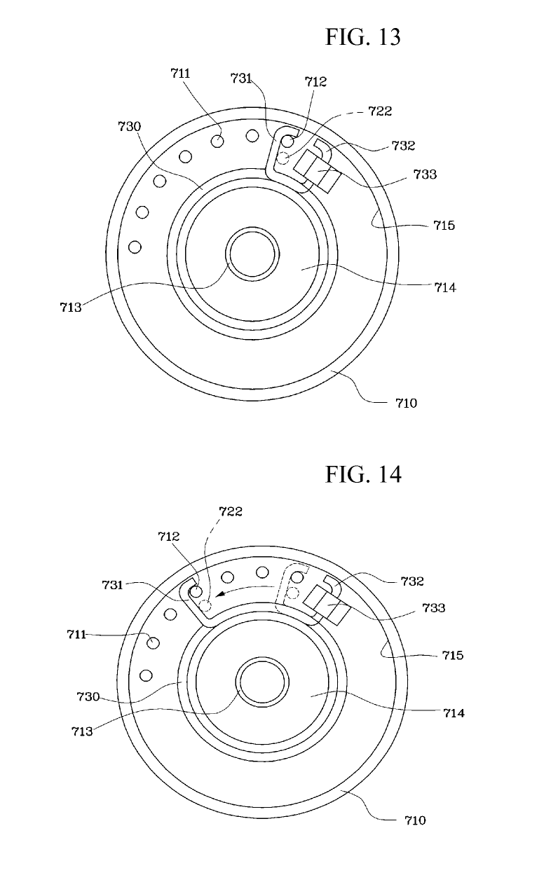

Before explaining the operation of the load balancer 700 in reference to FIGS. 13 through 14, the rotational direction of the rotational element 720 when the joint section of the polyarticular robot bends (or the direction where the load decreases or the direction of gravity) is determined as the normal direction, and the rotational direction (or the direction where the load increases or the opposite direction of gravity) when the joint section unbends is determined as the reverse direction.

In FIG. 14, when the rotational element 720 rotates to the normal direction as marked with the arrow, the rotation protrusion 722 attached to the rotational element 720 also rotates simultaneously and pushes the moving end section 731 of the elasticity element in the normal direction. Accordingly, the moving end section 731 of the elasticity element 730 moves to the normal direction while generating torque to the reverse direction. For example, the above illustrated movement corresponds with the case where the joint section bends to the direction of the gravity. In addition to the normal directional torque generated by the driving power of the actuator body 100 or the decelerator 200, the additional torque generated to normal direction by external forces such as gravity keeps an appropriate balance against the reverse directional torque generated by the load balancer 700, and thus enables natural rotation operation of the joint section.

Thereafter when the joint section unbends to the reverse direction against the direction of the gravity, the rotational element 720 begins the reverse rotation in opposite direction of the marked arrow. Since the reverse directional torque generated by the driving power of the actuator body 100 or decelerator 200 and the reverse directional compensation torque generated by the load balancer 700 are constructive to each other, a sufficient reverse directional torque can be obtained even in a situation where the normal directional torque generated by external forces such as gravity exists.

Even when large driving torque is needed on the joint section, the joint section can be formed using miniature actuators since the compensation torque is obtained using the load balancer 700 as mentioned above. Upon using the load balancer 700 the difference in required driving torque according to the driving direction of the joint section decreases, which can prevent or minimize the risk of overload of the actuator driving system, and the resultant power consumption, malfunction or breakdown of the actuator module. The amount of compensation torque can be estimated by the location of the insert holes 711, 721 where the reference protrusions 712 are inserted, which leads to easier programming for controlling the actuator's driving system.

The foregoing explanations of the present invention is not limited to the above embodiments, and it would be possible for those who have ordinary knowledge in the technical field where the present invention belongs to modify the present invention without departing from the technical scope of the present invention as defined by the accompanied claims.

What is claimed is:

1. An actuator module comprising: an actuator body including circuit parts and mechanical parts; and a decelerator that is connected to the actuator body to change the speed and the torque generated by the actuator body.

2. The actuator module of claim 1 wherein: the decelerator is separated from the actuator body and the actuator body and the decelerator is connected by a frame.

3. The actuator module of claim 1 wherein: the decelerator is directly and coaxially coupled with the actuator body.

4. The actuator module of claim 1 wherein: a load balancer is installed at the actuator body or the decelerator's rotation axle for the compensation of driving torque.

5. The actuator module of claim 1 wherein: a slip ring is installed at the actuator body or the decelerator's rotation axle.

6. The actuator module of claim 1 wherein: the decelerator is selected from the group consisting of a belt and pulley structure, a harmonic drive, and a gear structure.

7. The actuator module of claim 1 wherein: an encoder is formed at the actuator body or the decelerator, for sensing the operating status including rotation angle of the driving axle and feeding the sensed information back to the circuit parts of the actuator body.

8. The actuator module of claim 1 wherein: an external port is formed on one side of the actuator body for connection with an external sensor.

9. The actuator module of claim 2 wherein: the frame is a hinge structure that can be connected to at least one end of the actuator body or the decelerator.

10. The actuator module of claim 1 further comprising: an additional decelerator connected to the actuator body or the decelerator's driving axle to change the driving torque generated by the actuator body or the decelerator.

11. An actuator module comprising;
an actuator body generating driving power;
a decelerator connected to the actuator body to change the speed and the torque generated by the actuator body;
a frame interconnecting the actuator body and the decelerator;
a load balancer installed on the driving axle of the actuator body or the decelerator to compensate for the driving torque of the actuator body or the decelerator; and
a slip ring that is installed on the driving axle to supply electric power through the driving axle.

12. The actuator module of claim 11 wherein: the load balancer comprises a fixed element, a rotational element, and an elastic element that is provided between the fixed element and rotational element and generates compensation torque to the opposite direction of the rotational direction of the rotational element.

13. The actuator module of claim 12 wherein: the elastic element is a torsion spring, and the fixed element comprises a fixing member to secure the fixed end of the torsion spring on its inner surface, and the rotational element comprises a rotation protrusion that hangs on the moving end of the torsion spring to move according to the rotation of the rotational element.

14. The actuator module of claim 12 wherein: the fixed element comprises a first insert holes formed side by side on its inner surface for the insertion of the reference protrusion; a reference protrusion for defining the initial location of moving end of the elastic element to adjust the compensation torque generated by the torsion spring; and the rotational element comprises a second insert holes formed side by side on its inner surface in correspondence to the first insert holes for the insertion of the reference protrusion.
